(19) United States
(12) Patent Application Publication
(10) Pub. No.: US 2022/0028266 A1
(43) Pub. Date: Jan. 27, 2022

(54) Method, Device, Computer Program and Computer Program Product for Operating a Vehicle, and Vehicle

(71) Applicant: Bayerische Motoren Werke Aktiengesellschaft, Muenchen (DE)

(72) Inventors: Martin Bonfigt, Türkenfeld (DE); Katrin Alvarez Alvarez, Dachau (DE); Michael Bunk, München (DE); Thomas Gabler, München (DE); Alexander Harhurin, München (DE)

(21) Appl. No.: 17/311,557

(22) PCT Filed: Dec. 10, 2019
(86) PCT No.: PCT/EP2019/084298

§ 371 Date: Jun. 7, 2021

(51) Int. Cl. G08G 1/0967; G08G 1/00

(52) U.S. Cl. CPC G08G 1/096775; G08G 1/20

(57) ABSTRACT

In a method for operating a vehicle which has a communication interface, a position-determining unit and at least one road data set-determining unit, a database road data set is received by the communication interface, which data set is presumably made available by the database which is arranged externally with respect to the vehicle and which is representative of the position-dependent, road-related property. Depending on the database road data set and a vehicle road data set which is assigned thereto in terms of position, a trust characteristic value is determined which is representative of the level of trust in further database road datasets which relate to predefinable positions of the vehicle.

The invention relates to a method for operating a vehicle. The invention additionally relates to a device for operating a vehicle. The invention additionally relates to a computer program and computer program product for operating a vehicle. The invention additionally relates to a vehicle.

Databases can provide vehicles with data that can be used by vehicle functions.

The object on which the invention is based is to make a contribution to a high level of safety for the vehicle.

The object is achieved by the features of the independent patent claims. Advantageous configurations are identified in the subclaims.

According to a first aspect, the invention is distinguished by a method for operating a vehicle. The vehicle has a communication interface designed to interchange data with a database arranged externally to the vehicle. Additionally, the vehicle has a position determination unit designed to ascertain a vehicle position value that is representative of a current position of the vehicle. Additionally, the vehicle has at least one road dataset determination unit that has at least one assigned vehicle sensor and is designed to output vehicle road datasets that are representative of a position-dependent road-related property.

The invention is distinguished according to a second aspect by a device, wherein the device is designed to perform the method for operating a vehicle.

According to the first aspect, a database road dataset is received by the communication interface, said database road dataset supposedly being provided by the database arranged externally to the vehicle and said database road dataset being representative of the position-dependent road-related property. The database road dataset and a vehicle road dataset to be positionally assigned to said database road dataset are taken as a basis for ascertaining a confidence index that is representative of how high a level of confidence in further database road datasets relating to predefinable positions of the vehicle is.

This allows database road datasets provided by the database arranged externally to the vehicle to be checked for inaccurate and/or erroneous and/or manipulated data, and said data to be verified and/or validated. As a result, the database road datasets can be assigned a kind of quality stamp in order to either increase or reduce the integrity thereof.

By way of example, it is thus possible to draw conclusions about whether the database road datasets are manipulated and/or erroneous and/or incorrectly processed and/or inaccurate. This is advantageous in particular if the database road datasets are used for safety-critical vehicle functions of the vehicle, such as for example speed regulation, braking control, etc. By way of example, manipulated and/or erroneous and/or incorrectly processed database road sets can lead to the vehicle overestimating a grip of a road surface and traveling too fast around a curve, which can lead to great safety risks. It is therefore possible for the confidence index to be used for example such that it exerts an influence on a driving dynamics control system of the vehicle as dictated by a high level of safety.

In particular, it is therefore possible to draw such conclusions independently of the vehicle in real time. As a result, it is possible to minimize a susceptibility to error and also to lower a risk of accident. Real time comprises drawing such conclusions without a disadvantageous time delay, as could arise for example if this were not to be performed in the vehicle. Time-delayed correction of the relevant data, whether manually or by a vehicle fleet using an algorithm or by the database arranged externally to the vehicle, might not be in time. This can be seen in particular if for example database road sets were deliberately manipulated. By ascertaining the confidence index it is possible to prevent a multiplicity of vehicles from being directly exposed to a very high risk of accident following a deliberate manipulation of the database road sets. This is advantageous in particular in an autonomous driving mode.

The vehicle's predefinable positions of which the confidence index is representative are for example situated outside the current position. They can in particular relate to a route section to be traveled on, in particular a route section of predefinable length that follows the current position. Additionally, the predefinable positions of the vehicle for the confidence index can also include the current position of the vehicle.

All of the positions of the vehicle should be assigned to applicable times.

By way of example, database road datasets that are representative of a predefined route section that has been covered can be validated with the confidence index.

The confidence in further database road datasets can for example also include the current database road dataset.

It is advantageous if a respective fresh ascertainment of the confidence index is effected whenever the respective position is traveled through. As such, it is possible to make use of the knowledge that the position-dependent road-related property can change over time, for example over the course of a day. The database road dataset can for example comprise a normalization and/or a main value and/or a data sharpness index and/or a tolerance band, the tolerance band being representative of the maximum level that a divergence in the main value of the database road dataset can be at.

The vehicle road dataset can for example comprise a normalization and/or a main value and/or a data sharpness index and/or a tolerance band, the tolerance band being representative of the maximum level that a divergence in the main value of the vehicle road dataset can be at. The main value can for example be a mean value, a median or the like.

For the purposes of ascertaining the confidence index, a divergence in the database road dataset from the vehicle road dataset can be ascertained as a divergence index, and said divergence index can be taken as a basis for ascertaining the confidence index. The confidence index can for example have values on a continuous, in particular quasi-continuous, scale. Additionally, the confidence index can also have only discrete values. By way of example, discrete values can each be assigned to a confidence class. By way of example, a comparison of the respective divergence index with one and/or multiple threshold value(s) is taken as a basis for performing a classification into a respective confidence class, such as for example “trusted”, “not very well trusted”, “untrusted”, etc.

Additionally, for example an assignment can be made to a set of confidence traffic lights, whereby colored signaling of the confidence index, in particular when a user interface is present, can be prompted. By way of example, the confidence index is assigned to one of three discrete values that can be signaled by colors as “red”, “amber” and “green”, with “red” being representative of low confidence and “green” being representative of high confidence, for example.

Another possibility is for example also to assign only two confidence classes to the confidence index; in similar fashion to a Boolean variable, confidence either exists or does not.

The position-dependent road-related property is for example a vehicle-related coefficient of friction assigned to the vehicle that informs the vehicle about coefficient of friction conditions associated with a position. The coefficient of friction is a dimensionless measure of the frictional force compared with the contact force between two bodies; the coefficient of friction of a position is therefore different for every vehicle, since it is dependent not only on the road condition but also for example on the tires and the weight of the vehicle. Additionally, the position-dependent road-related property can also for example be: quality and/or condition of the road surface, damage to the road surface, and/or the topology, etc. A respective confidence index is ascertained for database road datasets that are representative of the respective position-dependent road-related properties.

The vehicle can for example be provided with database road datasets by various databases arranged externally to the vehicle. In this case, a respective confidence index, regarding the position-dependent road-related property, can be ascertained for database road datasets of the respective database.

According to one optional configuration, the confidence index is taken as a basis for initiating a predefined measure, specifically as a contribution to the safety of the vehicle.

This allows the safety of the vehicle to be ensured and/or increased, depending on the confidence index. By way of example, appropriate measures can be initiated for a confidence index whose value assignment is representative of low confidence.

By way of example, the confidence index can be taken as a basis for performing vehicle functions of the vehicle on the basis of the vehicle road datasets and/or the database road datasets. In the case of a confidence index whose value assignment is representative of low confidence, for example that respective vehicle road dataset and database road dataset that, in regard to the safety of the vehicle, makes a greater contribution to the safety of the vehicle is selected. By way of example, the applicable measures can be initiated in the event of the confidence index dropping below and/or rising above one or more predefined confidence levels.

The predefined measure can for example also comprise multiple predefined measures. The predefined measure can for example relate to the vehicle or the vehicle fleet and comprise safety measures and/or alternative measures. The predefined measure can for example relate to a braking assist system and/or an autonomous driving functions of the vehicle. Additionally, the predefined measure can for example relate to those vehicle functions of the vehicle that require information from the database road datasets and/or the vehicle road datasets. The predefined measure can for example prompt signaling of a driving intervention request to a driver in the event of autonomous driving mode and/or a speed reduction for the vehicle.

According to another optional configuration, the confidence index is ascertained by means of a predefined filtering.

This allows a sensitivity of the confidence index to be increased or reduced by means of the predefined filtering.

By way of example, the filtering can be used to statistically ascertain the confidence index. By way of example, database road datasets and vehicle road datasets of positions of a predefined route section that has been covered can be filtered, and this can be taken as a basis for ascertaining the confidence index. This allows database road datasets to be rated for a predefined route section.

The predefined filtering can for example comprise: an averaging and/or a moving averaging and/or a low-pass filtering and/or a high-pass filtering and/or a bandpass filtering and/or any other filtering. For example outliers can be taken into consideration in this case. Additionally, the filtering can for example take place over a specific period, wherein all of the positions of the vehicle should be assigned to applicable times. Additionally, the filtering can comprise outliers substantially not being taken into consideration or being taken into consideration to a lesser extent when ascertaining the confidence index.

Additionally, the filtering can comprise outliers being included in the ascertainment of the confidence index to a very great extent. Outliers, for example with reference to the divergence indexes, can be individual divergence indexes that diverge significantly from divergence indexes that should be arranged at positions before and/or after them.

According to another optional configuration, the confidence index is provided to the database arranged externally to the vehicle by means of the communication interface.

This allows specific confidence indexes or all of the confidence indexes to be made available to the database arranged externally to the vehicle. This allows the database arranged externally to the vehicle to make a contribution to the safety of other vehicles of the vehicle fleet, for example.

By way of example, the database arranged externally to the vehicle can send warnings for, by way of example, a specific route section to vehicles of the vehicle fleet, or can initiate independent alternative measures, in the event of a significant number of confidence indexes of multiple vehicles whose value assignments are representative of low confidence.

According to another optional configuration, the database road dataset comprises a data sharpness index, said data sharpness index being representative of how high an error bandwidth of the position-dependent road-related property represented by the database road dataset is. Additionally, the confidence index is ascertained on the basis of the data sharpness index.

As a result, it is possible, when ascertaining the confidence index, to take into consideration database road datasets having a low data sharpness index differently than database road datasets having a larger data sharpness index.

The level of the error bandwidth is for example dependent on various properties, outside influences, the source of the database road datasets, the accuracy and/or quality of the database road datasets.

By way of example, the error bandwidth may be greater if the database road dataset was ascertained using inaccurate models for the position-dependent road-related property. By way of example, a coefficient of friction can be assigned a greater error bandwidth if said coefficient of friction was ascertained using an inaccurate weather model.

According to another optional configuration, the database road dataset comprises a normalization with reference to a predefinable vehicle fleet.

This allows the database arranged externally to the vehicle to provide normalized database road datasets that can be used for the respective vehicle fleet.

The normalization is for example representative of a statistically ascertained position-dependent road-related property with reference to the respective vehicle fleet. The normalization is for example ascertained on the basis of vehicle road datasets of the vehicle fleet that were provided to the external database.

According to another optional configuration, during the ascertainment of the confidence index a vehicle-individual correction value is provided that is characteristic of a predefinable vehicle characteristic of the vehicle in comparison with the predefinable vehicle fleet and/or that is characteristic of a predefinable surroundings characteristic of the vehicle in comparison with the predefinable vehicle fleet. Additionally, the confidence index is ascertained on the basis of the vehicle-individual correction value and the normalization.

This allows the normalization to be adapted, or converted, for vehicle-individual circumstances. As a result, the database arranged externally to the vehicle can contain normalized database road datasets and does not have to provide database road datasets for every predefinable vehicle characteristic and/or surroundings characteristic of all of the vehicles of the vehicle fleet. As such, the vehicle can thus for example take into consideration just extremely small individual differences in the vehicle with reference to other vehicles of the vehicle fleet.

The vehicle-individual correction value can for example be used to take into consideration the different behavior of the wheels of the vehicle. By way of example, the vehicle-individual correction value can change over the life of the vehicle and for example take into consideration wear and tear.

The confidence index can be ascertained by adapting the vehicle road dataset and/or the database road dataset using the vehicle-individual correction value, the vehicle-individual correction value being used for example to convert and/or take into consideration a normalization for the individual vehicle characteristic and/or surroundings characteristic of the vehicle. By way of example, the vehicle road dataset is already adapted therefor and the database road dataset comprising the normalization is adapted for the individual vehicle characteristic and/or surroundings characteristic of the vehicle using the vehicle-individual correction value. By way of example, the normalization using the vehicle-individual correction value can be adapted in a denormalization such that the database road dataset and the vehicle road dataset are comparable. The denormalization comprises a transformation function, for example.

The vehicle characteristic can comprise for example information relating to a specific vehicle model (type, bodywork, etc.) and/or installed components of the vehicle (drive, motor, tires, etc.) and/or variable information (tire pressure, tire contact pressure on a road, vehicle weight on account of load, etc.). The surroundings characteristic can comprise for example information relating to current ambient conditions (rain, snow, ice, wind, weather, air pressure, sea level, etc.), road condition (potholes, coefficient of friction, road soiling, etc.).

According to a second aspect, the invention is distinguished by a device for operating a vehicle that has a communication interface designed to interchange data with a database arranged externally to the vehicle. Additionally, the vehicle has a position determination unit designed to ascertain a vehicle position value that is representative of a current position of the vehicle. Additionally, the vehicle has at least one road dataset determination unit that has at least one assigned vehicle sensor and is designed to output vehicle road datasets that are representative of a position-dependent road-related property. The device is designed to carry out the method for operating the vehicle according to the first aspect.

According to another aspect, the invention is distinguished by a vehicle that has a communication interface designed to interchange data with a database arranged externally to the vehicle. Additionally, the vehicle has a position determination unit designed to ascertain a vehicle position value that is representative of a current position of the vehicle. Additionally, the vehicle has at least one road dataset determination unit that has at least one assigned vehicle sensor and is designed to output vehicle road datasets that are representative of a position-dependent road-related property. Additionally, the vehicle has the device for operating the vehicle.

According to another aspect, the invention is distinguished by a computer program, wherein the computer program comprises instructions that, when the program is executed by a computer, prompt the computer to carry out the method for operating a vehicle. According to another aspect, the invention is distinguished by a computer program product comprising executable program code, wherein the program code, when executed by a data processing device, performs the method for operating a vehicle.

The computer program product in particular comprises a medium that can be read by the data processing device and on which the program code is stored.

Exemplary embodiments of the invention are explained in more detail below with reference to the schematic drawings, in which:

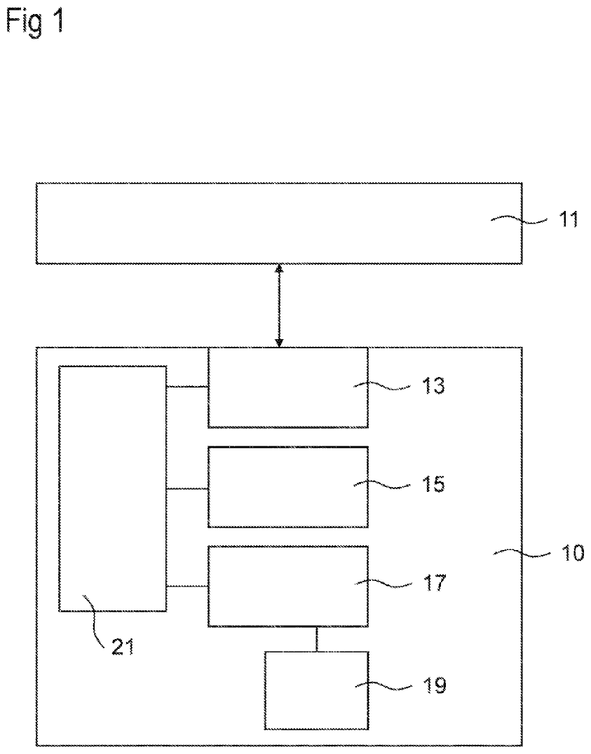

FIG. 1 shows a schematic drawing of the vehicle and the database arranged externally to the vehicle;

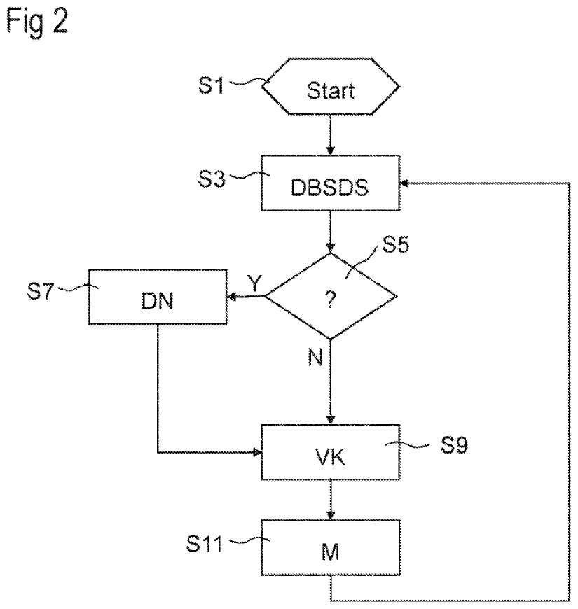

FIG. 2 shows a flowchart for operating a vehicle, and

FIG. 1 shows a schematic drawing of the vehicle 10 and the database 11 arranged externally to the vehicle. The database 11 arranged externally to the vehicle 10 can for example comprise a cloud or the like. The vehicle 10 has a communication interface 13 designed to interchange data with a database 11 arranged externally to the vehicle 10. Additionally, the vehicle 10 has a position determination unit 15 designed to ascertain a vehicle position value that is representative of a current position of the vehicle 10. Additionally, the vehicle 10 has at least one road dataset determination unit 17 that has at least one assigned vehicle sensor 19 and is designed to output vehicle road datasets that are representative of a position-dependent road-related property. Additionally, the vehicle 10 has a device 21 for operating the vehicle 10. The device 21 in particular comprises a program and/or data memory and a computing unit. The program and/or data memory stores a program for operating the vehicle that can be executed by the computing unit. The program and data memory and/or the computing unit can be in a form such that they are in one physical unit and/or distributed over multiple physical units.

FIG. 2 shows a flowchart for the program for operating a vehicle 10.

The program is started in a step S1, in which variables are initialized if necessary.

In a step S3, a database road dataset is received by the communication interface 13, said database road dataset supposedly being provided by the database 11 arranged externally to the vehicle and said database road dataset being representative of a position-dependent road-related property.

The communication interface 13 is designed to interchange data with the database 11 arranged externally to the vehicle.

The position-dependent road-related property is for example a vehicle-related coefficient of friction assigned to the vehicle 10 that informs the vehicle 10 about coefficient of friction conditions associated with a respective position. The coefficient of friction is a dimensionless measure of the frictional force compared with the contact force between two bodies; the coefficient of friction of a position is therefore different for every vehicle 10, since it is dependent not only on the road condition but also for example on the tires and the weight of the vehicle 10.

In an optional step S5, a check is performed to determine whether the database road dataset comprises a normalization with reference to a predefinable vehicle fleet. If this is the case, execution of the program is continued in step S7, otherwise in step S9.

The normalization is for example representative of a statistically ascertained position-dependent road-related property of the vehicle 10 with reference to a vehicle fleet.

In an optional step S7, a vehicle-individual correction value is provided that is characteristic of a predefinable vehicle characteristic of the vehicle 10 in comparison with the predefinable vehicle fleet and/or that is characteristic of a predefinable surroundings characteristic of the vehicle 10 in comparison with the predefinable vehicle fleet. Additionally, a denormalization of the database road dataset is carried out on the basis of the vehicle-individual correction value and the normalization.

The denormalization can for example comprise a transfer function, on the basis of the vehicle-individual correction value. By way of example, the vehicle road dataset is already adapted for the predefinable vehicle characteristic of the vehicle 10, and the database road dataset, comprising the normalization, is adapted for the predefinable vehicle characteristic of the vehicle 10 on the basis of the vehicle-individual correction value in the denormalization.

In a step S9, the database road dataset and a vehicle road dataset to be positionally assigned to said database road dataset are taken as a basis for ascertaining a confidence index that is representative of how high a level of confidence in further database road datasets relating to predefinable positions of the vehicle 10 is.

For the purpose of ascertaining the confidence index, for example a divergence index can be ascertained, specifically on the basis of a divergence in the respective database road dataset and the respective vehicle road dataset.

The database road dataset and the vehicle road dataset can for example comprise a main value and/or a data sharpness index and/or a tolerance band, the tolerance band being representative of the maximum level that a divergence in the main value of the database road dataset can admissibly be at. The data sharpness index is representative of how high an error bandwidth of the position-dependent road-related property represented by the database road dataset is. By way of example, the divergence index can be ascertained as the difference between the main value of the database road dataset and the main value of the vehicle road dataset. The divergence index can then be compared with one or more threshold values. By way of example, a difference between the data sharpness index of the database road dataset and the data sharpness index of the vehicle road dataset can be ascertained that is compared with the threshold value. By way of example, a difference between the tolerance band of the database road dataset and the tolerance band of the vehicle road dataset can be ascertained that is compared with the threshold value.

By way of example, the difference for the main value and the difference for the tolerance band can be taken as a basis for determining the confidence index. By way of example, a database road dataset is trusted if it comprises a tolerance band that is smaller than that of the vehicle road dataset to be positionally assigned.

The vehicle road dataset is representative of the position-dependent road-related property and is output by a road dataset determination unit 17 that has at least one assigned vehicle sensor 19.

The positional assignment comprises a position determination unit 15 designed to ascertain a vehicle position value that is representative of a current position of the vehicle. By way of example, the current position is ascertained by means of one or more global navigation satellite systems, GNSS.

Optionally, the confidence index can be ascertained by means of a predefined filtering.

The predefined filtering can for example comprise: an averaging and/or a moving averaging and/or a low-pass filtering and/or a high-pass filtering and/or a bandpass filtering and/or any other filtering. For example outliers can be taken into consideration in this case. Additionally, the filtering can for example take place over a specific period, wherein all of the positions of the vehicle 10 should be assigned to applicable times. Additionally, the filtering can comprise outliers not being taken into consideration or being taken into consideration to a lesser extent when ascertaining the confidence index. Additionally, the filtering can comprise outliers being included in the ascertainment of the confidence index to a very great extent.

In a step S11, the confidence index is taken as a basis for initiating a predefined measure, as a contribution to the safety of the vehicle 10. Optionally, the confidence index is provided to the database 11 arranged externally to the vehicle by means of the communication interface 13.

Subsequently, the program is started again in step S3.

1.-11. (canceled)

12. A method for operating a vehicle having
a communication interface designed to interchange data with a database arranged externally to the vehicle,
a position determination unit designed to ascertain a vehicle position value that is representative of a current position of the vehicle, and
at least one road dataset determination unit that has at least one assigned vehicle sensor and is designed to output vehicle road datasets that are representative of a position-dependent road-related property,
the method comprising:
receiving a database road dataset by the communication interface, said database road dataset supposedly being provided by the database arranged externally to the vehicle and said database road dataset being representative of the position-dependent road-related property, and
using the database road dataset and a vehicle road dataset to be positionally assigned to said database road dataset as a basis for ascertaining a confidence index that is representative of how high a level of confidence in at least one further database road dataset relating to predefinable positions of the vehicle is.

13. The method as claimed in claim 12, further comprising using the confidence index as a basis for initiating a predefined measure, as a contribution to the safety of the vehicle.

14. The method as claimed in claim 12, wherein the confidence index is ascertained by means of a predefined filtering.

15. The method as claimed in claim 12, further comprising providing the confidence index to the database arranged externally to the vehicle by means of the communication interface.

16. The method as claimed in claim 12, wherein
the database road dataset comprises a data sharpness index, said data sharpness index being representative of how high an error bandwidth of the position-dependent road-related property represented by the database road dataset is, and
the confidence index is ascertained on the basis of the data sharpness index.

17. The method as claimed in claim 12, wherein the database road dataset comprises a normalization with reference to a predefinable vehicle fleet.

18. The method as claimed in claim 17, wherein during the ascertainment of the confidence index,
a vehicle-individual correction value is provided that is characteristic of a predefinable vehicle characteristic of the vehicle in comparison with the predefinable vehicle fleet and/or that is characteristic of a predefinable surroundings characteristic of the vehicle in comparison with the predefinable vehicle fleet, and
the confidence index is ascertained on the basis of the vehicle-individual correction value and the normalization.

19. A device for operating a vehicle having
a communication interface designed to interchange data with a database arranged externally to the vehicle,
a position determination unit designed to ascertain a vehicle position value that is representative of a current position of the vehicle, and
at least one road dataset determination unit that has at least one assigned vehicle sensor and is designed to output vehicle road datasets that are representative of a position-dependent road-related property,
the device configured to carry out the method as claimed in claim 12.

20. A vehicle, comprising:
a communication interface designed to interchange data with a database arranged externally to the vehicle,
a position determination unit designed to ascertain a vehicle position value that is representative of a current position of the vehicle,
at least one road dataset determination unit that has at least one assigned vehicle sensor and is designed to output vehicle road datasets that are representative of a position-dependent road-related property, and
the device as claimed in claim 19.

21. A computer program, wherein the computer program comprises instructions that, when the program is executed by a computer, prompt the computer to carry out the method as claimed in claim 12.

22. A computer program product comprising executable program code, wherein the program code, when executed by a data processing device, performs the method as claimed in claim 12.

23. A computer program product comprising executable program code, wherein the program code, when executed by a data processing device, performs the method as claimed in claim 13.

24. A computer program product comprising executable program code, wherein the program code, when executed by a data processing device, performs the method as claimed in claim 14.

25. A computer program product comprising executable program code, wherein the program code, when executed by a data processing device, performs the method as claimed in claim 15.

26. A computer program product comprising executable program code, wherein the program code, when executed by a data processing device, performs the method as claimed in claim 16.

27. A computer program product comprising executable program code, wherein the program code, when executed by a data processing device, performs the method as claimed in claim 17.

28. A computer program product comprising executable program code, wherein the program code, when executed by a data processing device, performs the method as claimed in claim 18.
